(19) United States
(12) Patent Application Publication
(10) Pub. No.: US 2016/0214147 A1
(43) Pub. Date: Jul. 28, 2016

(54) KNIFE BLOCK SANITIZER

(71) Applicant: The Academy of Bacteriology, LLC, Boynton Beach, FL (US)

(72) Inventor: Kenneth G. LOCKARD, Boynton Beach, FL (US)

(21) Appl. No.: 14/606,174

(22) Filed: Jan. 27, 2015

(51) Int. Cl. B08B 3/02

(52) U.S. Cl. CPC B08B 3/026

(57) ABSTRACT

Disclosed is a novel single spray attachment for a spray bottle. A spray dispensing device made of a molded material which allows a fluid chemical composition of sanitizing fluid to be forcefully discharged through it into the small opening cut outs of a knife block. The device serves as a guard to enter the opening and protect a splash back from occurring when the user applies a sanitizing fluid spray solution by pressure into the inside portion of the knife block slots which are of various sizes.

### BACKGROUND

The present invention generally relates to nozzles attached to spray bottles, and more specifically to a spray bottle attachment for sanitizing knife blocks.

### SUMMARY

The presently claimed invention discloses a knife block spray sanitizer system for safely dispensing sanitizer fluid into the open slots of a knife block. The knife block spray sanitizer system uses an improved spray-attachment for safely dispensing sanitizing fluid into the open slots of a knife block is described. The spray-attachment includes a rear intake side for working with commercially available pump heads that include an “on” and “off” rotatable outlet valve. The pump head provides pressurized sanitizing fluid that is sprayed out of the front discharge end. The front discharge end includes a substantially flat splash guard and a substantially rectangular slot guide disposed on the flat splash guard.

The rectangular slot guide includes one or more ejection ports or nozzles. The nozzles are in fluid communication with the cylindrical head pass channel for directing the pressurized fluid therefrom. The rectangular slot guide is specifically sized to fit within the various small knife block slots. A user upon engaging the trigger on a nozzle spraying device will cause the solution within the spray bottle to be broadcast through the orifices of the splash guard to the inside of the knife block slot. The splash guard stops splash back of sanitizer liquid coming out of the knife block onto items surrounding the knife block.

### BRIEF DESCRIPTION OF THE SEVERAL VIEWS OF THE DRAWINGS

The accompanying figures wherein reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a front perspective of knife block sanitizer assembly showing sanitizer head turned in an “on” position;

FIG. 2. is a front perspective of knife block sanitizer assembly showing sanitizer head turned in an “off” position;

FIG. 3 is a front perspective detail of the pump head showing sanitizer head removed with channel plug and sanitizer nozzles exploded from sanitizer head;

FIG. 4 is a side detail of sanitizer assembly with sanitizer head turned in an “on” position;

FIG. 5 is a front detail of FIG. 4;

FIG. 6 is a top section detail of FIG. 4;

FIG. 7 is a side detail of sanitizer assembly with sanitizer head turned in an “off” position;

FIG. 8 is a front detail of FIG. 7;

FIG. 9 is a top section detail of FIG. 7;

FIG. 10 is a front perspective view of sanitizer head;

FIG. 11 is a rear perspective view of sanitizer head;

FIG. 12 is a rear view of sanitizer head;

FIG. 13 is a front view of sanitizer head;

FIG. 14 is a top view of sanitizer head;

FIG. 15 is a side view of sanitizer head (109);

FIG. 16 is a top perspective view of sanitizer assembly in position to be inserted into slot of knife block;

FIG. 17 is a top perspective view of sanitizer assembly inserted into slot of knife block; and

FIG. 18 is a side section view of FIG. 17 showing the rectangular slot guide of the sanitizer head inserted into a slot of the knife block.

### DETAILED DESCRIPTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The description of the presently claimed invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

### Overview

A “knife block” is a block of solid material, typically wood or plastic containing long grooves in which kitchen knives of various sizes can be inserted up to the handle. The slots are sized to accept a knife blade into it. Typically the slots are formed such that it is impossible to have access of the interior of the small slots openings. Contaminants are easily transmitted by knives inserted into the slots that were perhaps previously used to cut raw foods that were not cleaned or sanitized properly before replacing them back to the knife block. Studies made in 2013 by the N.S.F. National Sanitizing Foundation which is a worldwide agency and approved by the U.S. Government proved the following. Among the top 20 kitchen work items containing dangerous bacteria, their studies proved that the knife block was among the top three most dangerous items. Improperly washed knives returned to the knife block develop dangerous food born bacteria and germs in the dark moist and unattended environment of the small knife block slots. This, combined with the introduction of residue on the knives encourages this germ and bacteria growth that can bring about illness and even death. Therefore reducing and eliminating harmful germs, bacteria, and contaminants developing inside the slots of a knife block is a problem identified by the inventor.

Furthermore, the problem of achieving the sanitizing objective without a back splash or cover of some type when trying to spray liquids into these small multiple slots without a cover or guard of some type with today's large common spray tips has been identified as dangerous by the inventor.

### Sanitizer Assembly

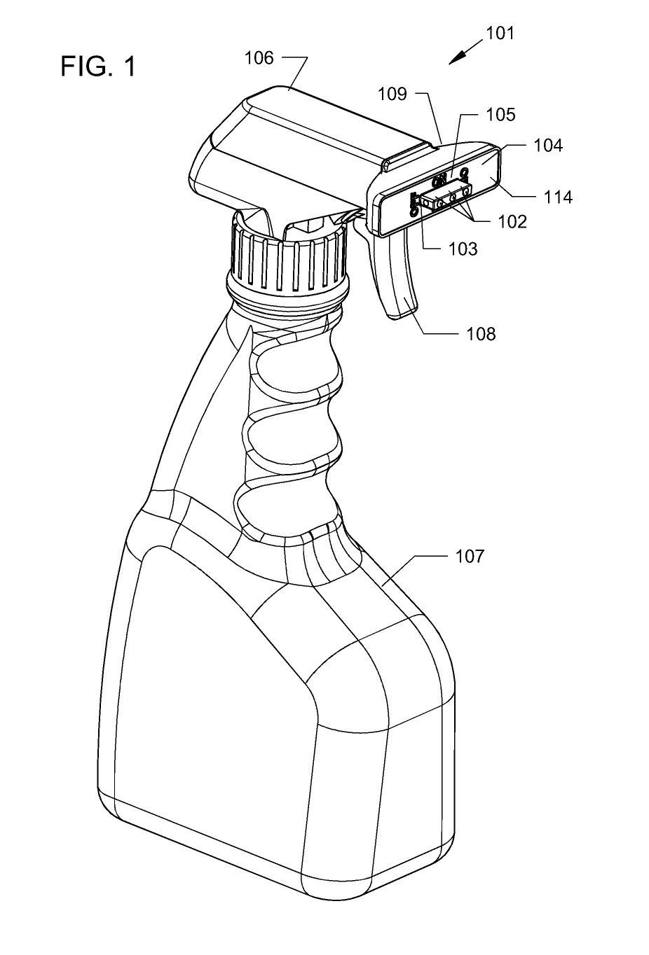

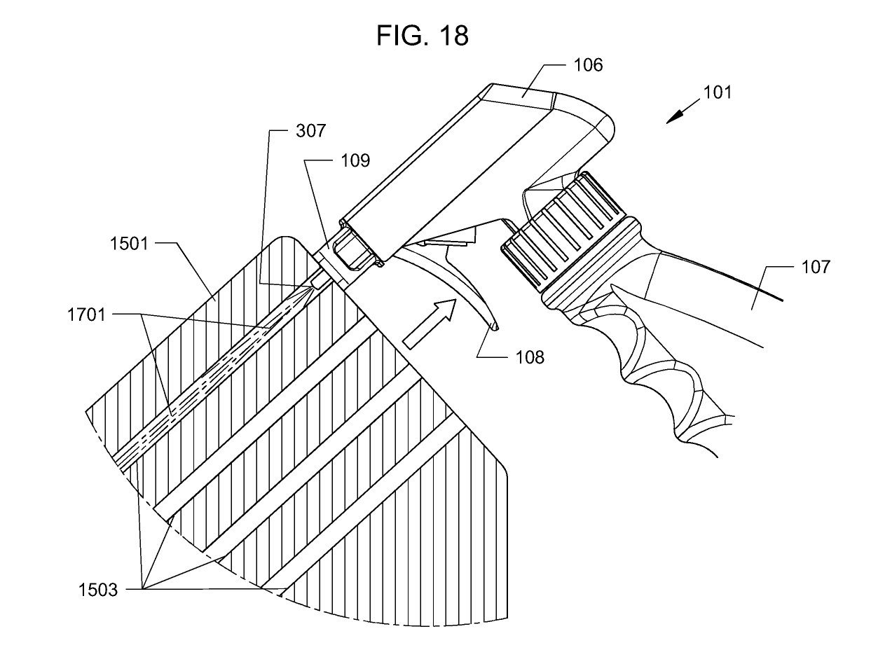

FIG. 1 is a front perspective of knife block sanitizer assembly (101) showing sanitizer head (109) turned in an “off” position. Shown is a bottle or fluid container (107) for holding sanitizing liquid. The fluid container is any material including metal, plastics, composites, or a combination thereof. A spray pump head (106) with a spray lever (108) is attached to the fluid container (107). In one example, the spray pump head (106) includes a suction tube not shown. One end of the suction tube is attached to the spray pump head (106) and the other end is inserted into the sanitizer liquid inside the fluid container (107). A spray-attachment (109) is mechanically coupled to the spray pump head (106). In other example, the spray-attachment (109) is mechanically attached to a fluid container which is pressurized (not shown), such as an aerosol can. The spray-attachment includes a substantially flat splash guard (104) that forms part of the front discharge side (114). A substantially rectangular slot guide (105) is disposed on the splash guard (104) as shown. The rectangular slot guide (105) is sized to fit inside into the slots (1503 of FIG. 18) of the knife block (1501 of FIG. 18) as shown in. 16-19. The rectangular slot guide (105) includes one or more nozzles (102) that distributes liquid into a spray over the slots (1503 of FIG. 18) of the knife block (1501 of FIG. 18).

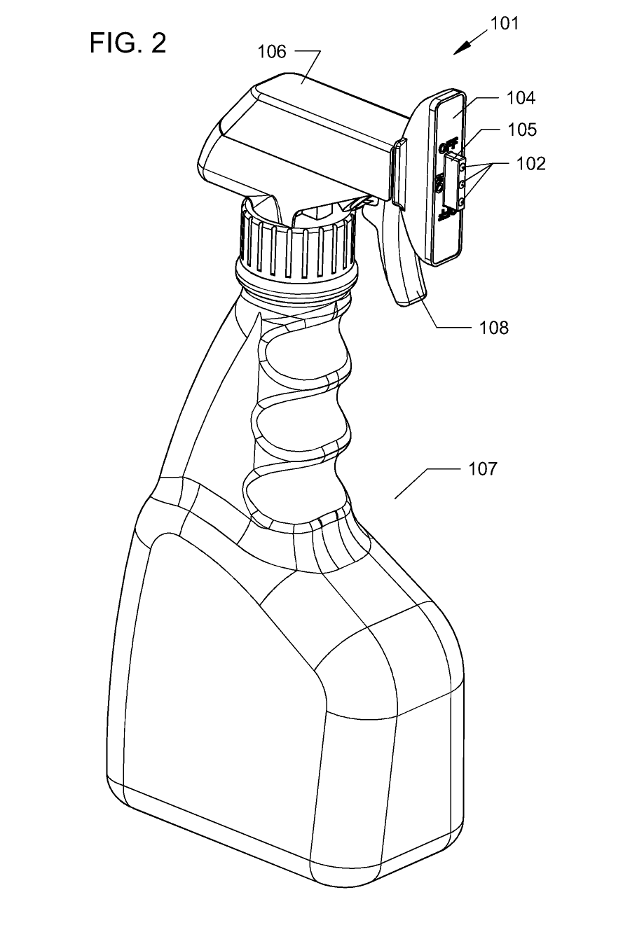

In one example the sanitizer head (109) has two positions a first position “off” to prohibit spray to discharge and a second position “on” to allow spray to discharge. The first position or “off position” is shown in FIG. 1. FIG. 2 illustrates rotating the sanitizer head (109) approximately 90 degrees turns the sanitizer head (109) to a second position or “on position”.

### Sanitizer Head

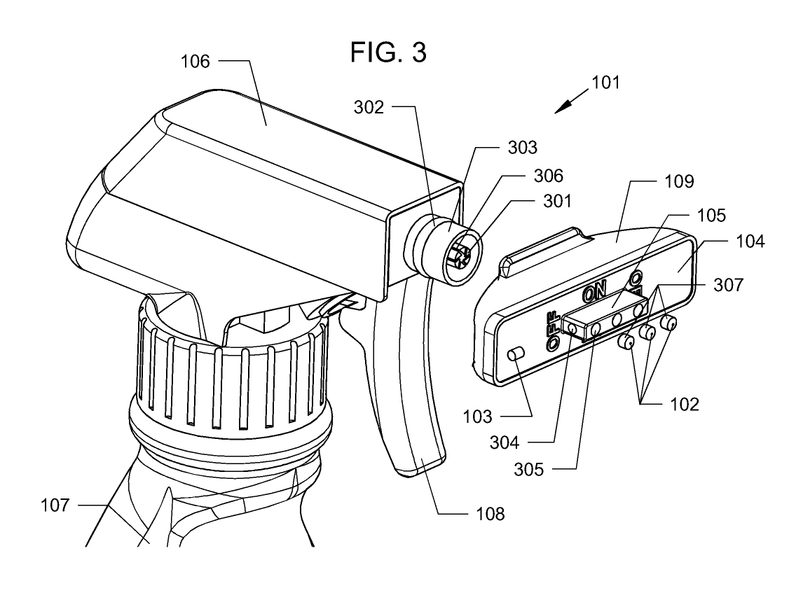

FIG. 3 is a front perspective detail of the spray pump head (106) showing sanitizer head (109) removed with channel plug (103) and sanitizer nozzles (102) exploded from sanitizer head (109). The spray pump head (106) includes a substantially cylindrical pump head attachment boss (303). A snap ring (302) on the outer surface of the pump head attachment boss (303) keeps the sanitizer head (109) firmly in place. Disposed inside the pump head boss (303) is a mixing post (301). The mixing post (301) cooperates a rear intake side (FIG. 11) of the sanitizer head (109) to form an “on” and “off” valve.

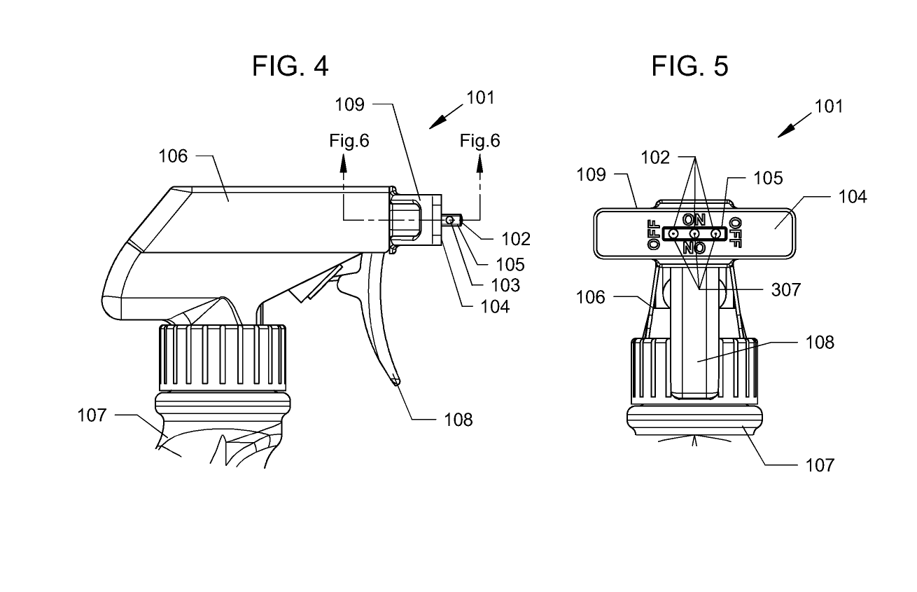

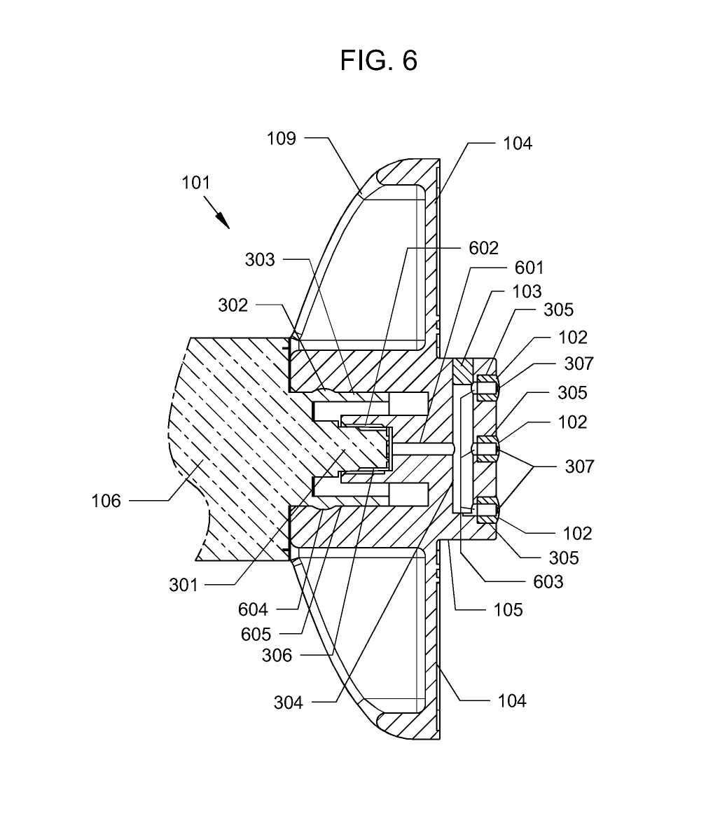

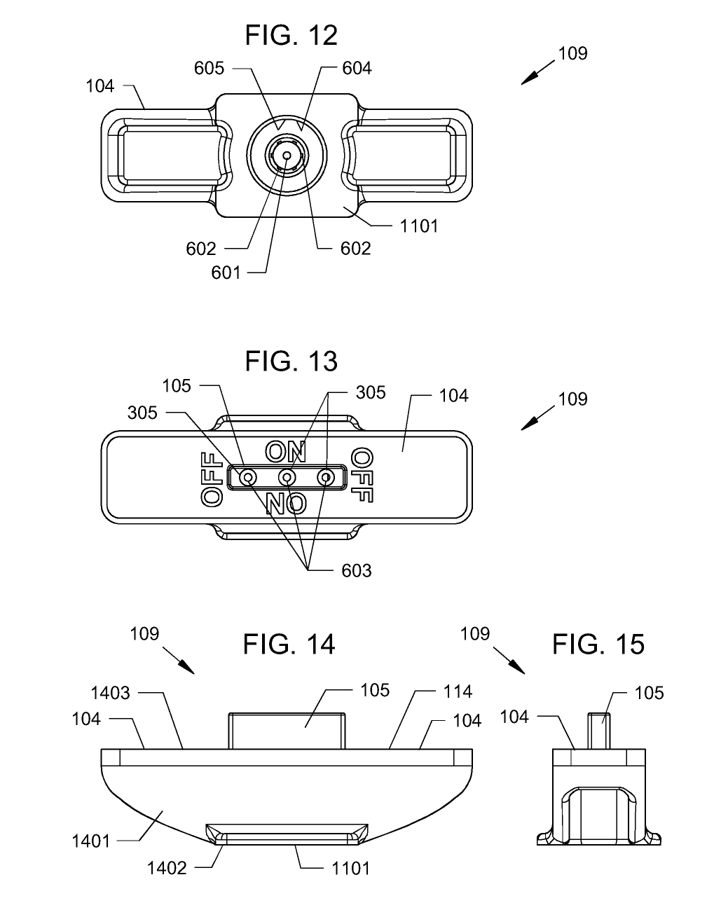

FIG. 4 is a side detail of sanitizer assembly (101) with sanitizer head (109) turned in an “off” position and FIG. 5 is a front detail of FIG. 4. FIG. 6 is a top section detail of FIG. 4. Shown are the interior channels to allow sanitizer fluid to flow under pressure from the spray pump head (106) out through to sanitizer nozzles (102). The interior channels include a cylindrical head pass channel (602), a supply channel (601), and nozzle supply channel manifold (603) all providing a continuous fluid communication between the spray pump head (106) and sanitizer nozzles (102). As shown in FIG. 4 and FIG. 12 the cylindrical head pass channel (602) is disposed within the circular head attachment cavity (605). Further, the supply channel (601) is disposed within the cylindrical head (1102). Also shown is one or more ridges or snap ring (604) on the inner side wall (of the sanitizer head attachment cavity (605) that keeps the sanitizer head (109) firmly in attached. A series of head pass channels (602) are formed in the inner side wall (1116) of the cylindrical head (1102). The head pass channels in one position cooperate with the mixing post pass channels (306 of FIG. 3) of the mixing post (301) to create “on” and “off” valve.

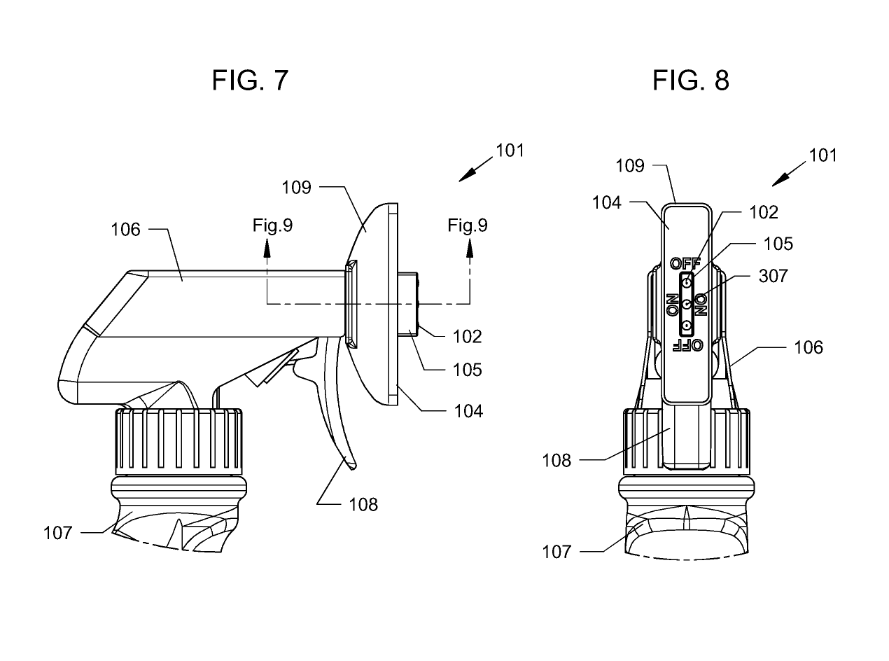

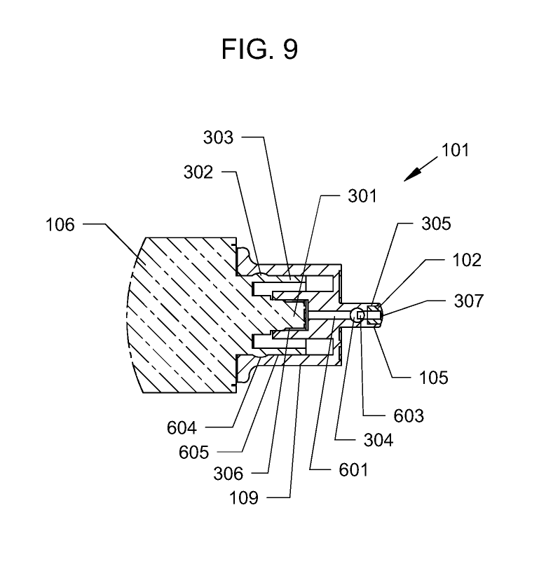

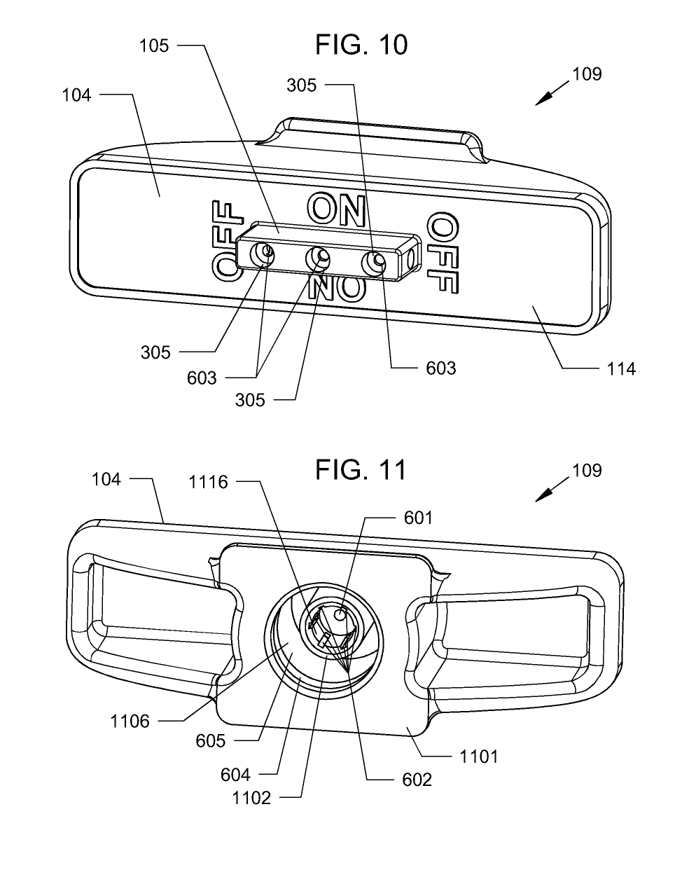

FIG. 7 is a side detail of sanitizer assembly (101) with sanitizer head (109) turned in an “off” position. FIG. 8 is a front detail of FIG. 7 and FIG. 9 is a top section detail of FIG. 7. FIG. 10 is a front perspective view of sanitizer head (109) and FIG. 13 is a front view illustrating of sanitizer head (109) a front discharge side (114). FIG. 11 is a rear perspective view of sanitizer head (109) and FIG. 12 is a rear view of sanitizer head (109) illustrating the rear intake side (1101). FIG. 14 is a top view of sanitizer head (109). In this example, the top view of the sanitizer head (109) is shaped substantially like an isosceles trapezoid (1401). The shorter edge (1402) of the isosceles trapezoid (1401) defining the rear intake side (1101) and the longer edge (1403) of the isosceles trapezoid (1401) defining the front discharge size (1403). FIG. 15 is a side view of sanitizer head (109).

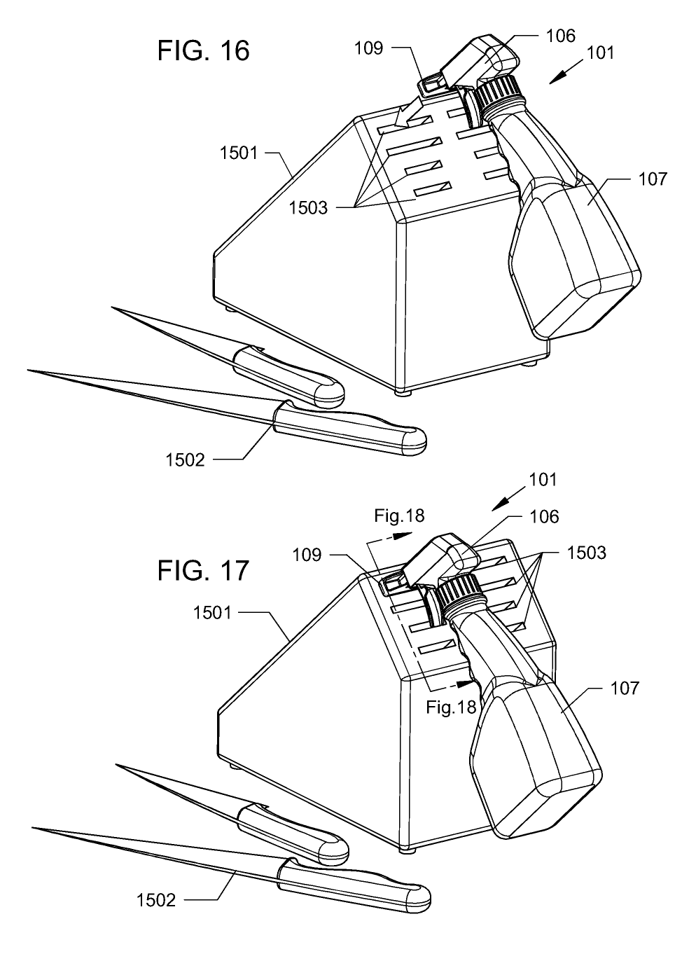

FIG. 16 is a top perspective view of sanitizer assembly (101) in position to be inserted into slot (1503) of knife block (1501) and FIG. 17 is a top perspective view of sanitizer assembly (101) inserted into slot (1503) of knife block (1501).

FIG. 18 is a side section view of FIG. 17 showing the slot insert boss (105) of the sanitizer head (109) inserted into a slot (1503) of the knife block (1501). The nozzle spray orifices (307) can be seen spraying sanitizer fluid (1701) into the slot (1503).

In order to properly insert inside a slot of a knife block (1501), the rectangular slot guide (105) has a width approximately between 0.050 and 0.200 inches and in one example the width is approximately 0.100 inches. The length of the rectangular slot guide (105) is approximately between 0.200 and 0.800 inches and in one example the length is approximately 0.625 inches. The depth of the rectangular slot guide (105) is approximately between 0.100 and 0.400 inches and in one example the depth is 0.200 inches.

All fluids based upon or containing anti-bacterial compounds, anti-viral compounds, and/or anti-fungal compounds properties could be used in the device including but not limited to ones based on vinegar, alcohol, iodine, silver, silver nitrate, zinc, citric acid, hydrogen peroxide as well as combinations and compounds thereof.

Although a clear sanitizing fluid as used in one embodiment of the presently claimed invention, other types of sanitizing fluids and foams may be dispensed in various forms by the nozzle trigger including fluids, liquids, aerosols, sprays, streams and/or the like.

Further, although the presently claim invention is directed to decontamination and sanitizing knife blocks, other kitchen products, especially kitchen products with porous surfaces have been shown to be successfully decontaminated and sanitized. Kitchen products with porous surfaces, such as wood, are particularly difficult to properly clean. Using the currently claim invention, kitchen products with porous surfaces are including cutting boards, spoon rests, utensils, and bowls are decontaminated and sanitized as well.

### Non-Limiting Examples

The terminology used herein is for the purpose of describing particular examples only and is not intended to be limiting of the invention. As used herein, the singular forms “a”, “an” and “the” are intended to include the plural forms as well, unless the context clearly indicates otherwise. The term another, as used herein, is defined as at least a second or more. The terms “including” and “having” as used herein, are defined as comprising (i.e. open language). The term “coupled” as used herein, is defined as “connected” although not necessarily directly.

The description of the present application has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A spray-attachment comprising:
a nozzle with front discharge side and a rear intake side,
the rear intake side including an circular head attachment cavity, a cylindrical head disposed within the circular head attachment cavity, and a supply channel disposed within the cylindrical head for receiving a pressurized fluid; and
the front discharge side with a substantially flat splash guard and a substantially rectangular slot guide disposed thereon, the rectangular slot guide including a plurality of nozzles in fluid communication with the cylindrical head for directing the pressurized fluid therefrom.

2. The spray-attachment of claim 1, wherein the rectangular slot guide has a width between 0.050 and 0.200 inches and a length between 0.200 and 0.800 inches.

3. The spray-attachment of claim 1, wherein the rectangular slot guide protrudes from the flat splash guard between 0.100 inches and 0.400 inches.

4. The spray-attachment of claim 1, wherein the nozzle has a supply channel manifold formed therein, the supply channel in fluid communications between the supply channel and the plurality of plurality of nozzles.

5. The spray-attachment of claim 1, wherein the nozzle is substantially shaped as an isosceles trapezoid with a shorter edge defining the rear intake side and a longer edge defining the front discharge side, and the rectangular slot guide disposed on along the longer edge.

6. The spray-attachment of claim 1, wherein the circular head attachment cavity includes an inner side wall with one or more ridges disposed thereon.

7. The spray-attachment of claim 1, wherein the supply channel disposed within the cylindrical head for receiving the pressurized fluid is further adapted to mechanically couple with a mixing post of a spray pump head to create an outlet valve, the outlet valve has an on position and an off position.

8. The spray-attachment of claim 7, wherein the outlet valve is formed by a series of head pass channels formed in an inner side wall of the cylindrical head, the head pass channels are in fluid communication with the supply channel during the on position.

9. The spray-attachment of claim 1, wherein the plurality of nozzles in fluid communication with the circular head attachment cavity are configured to direct the pressurized fluid therefrom in at least one of a spray, a foam, a stream, or a combination thereof.

10. A knife block spray sanitizer system comprising:
a fluid container;
a pump head with a spray lever, mechanically attachable to the fluid container, the pump head including pump head attachment boss with a mixing post for discharging a pressurized fluid therefrom;
a nozzle with front discharge side and a rear intake side,
the rear intake side including an circular head attachment cavity, a cylindrical head disposed within the circular head attachment cavity, and a supply channel disposed within the cylindrical head for receiving a pressurized fluid from the mixing post; and
the front discharge side with a substantially flat splash guard and a substantially rectangular slot guide disposed thereon, the rectangular slot guide including a plurality of nozzles in fluid communication with the supply channel for directing the pressurized fluid therefrom.

11. The knife block spray sanitizer system of claim 10, wherein the rectangular slot guide has a width between 0.050 and 0.200 inches and a length between 0.200 and 0.800 inches.

12. The knife block spray sanitizer system of claim 10, wherein the rectangular slot guide protrudes from the flat splash guard between 0.100 inches and 0.400 inches.

13. The knife block spray sanitizer system of claim 10, wherein the nozzle has a supply channel manifold formed therein, the supply channel in fluid communications between the supply channel and the plurality of nozzles.

14. The knife block spray sanitizer system of claim 10, wherein the nozzle is substantially shaped as an isosceles trapezoid with a shorter edge defining the rear intake side and a longer edge defining the front discharge side, and the rectangular slot guide disposed on along the longer edge.

15. The knife block spray sanitizer system of claim 10, wherein the circular head attachment cavity includes an inner side wall with one or more ridges disposed thereon.

16. The knife block spray sanitizer system of claim 10, wherein the supply channel disposed within the cylindrical head for receiving the pressurized fluid is further adapted to mechanically couple with a mixing post of a spray pump head to create an outlet valve, the outlet valve has an on position and an off position.

17. The knife block spray sanitizer system of claim 16, wherein the outlet valve is formed by a series of head pass channels formed in an inner side wall of the cylindrical head, the head pass channels are in fluid communication with the supply channel during the on position.

18. The knife block spray sanitizer system of claim 10, wherein the plurality of nozzles in fluid communication with the circular head attachment cavity are configured to direct the pressurized fluid therefrom in at least one of a fluid spray, a foam, a stream, or a combination thereof.

19. The knife block spray sanitizer system of claim 10, wherein the fluid includes at least one of anti-bacterial compounds, anti-viral compounds, anti-fungal compounds, or a combination thereof.
